(19) United States
(12) Patent Application Publication
(10) Pub. No.: US 2010/0178505 A1
(43) Pub. Date: Jul. 15, 2010

(54) FIBERS AND FIBER-BASED SUPERSTRUCTURES, THEIR PREPARATION AND USES THEREOF

(76) Inventors: Gregory C. RUTLEDGE, W. Nowton, MA (US); Minglin Ma, Cambridge, MA (US)

Correspondence Address: Pearl Cohen Zedek Latzer, LLP, 1500 Broadway, 12th Floor, New York, NY, 10036, US

(21) Appl. No.: 12/640,856

(22) Filed: Dec. 17, 2009

Related U.S. Application Data
(60) Provisional application No. 61/138,441, filed on Dec. 17, 2008.

(51) Int. Cl. D02G 3/36; D02G 3/00; C08F 20/06; C08F 20/10; C08G 77/38; C08G 59/14; C08G 63/00; C08F 20/44; C08F 12/08; C08F 36/06; B29C 47/08

(52) U.S. Cl. 428/394; 428/401; 525/50; 525/55; 525/474; 525/523; 525/415; 264/465; 977/762

(57) ABSTRACT

This invention is directed to fibers comprising copolymers or homopolymer blends, superstructures comprising said fibers, process for the preparation of the same and uses thereof. The fibers of this invention have long range order and superstructures produced from said fibers can be used in applications including but not limited to membranes, filtration media, high surface area substrates for sensors and catalysis, stents, tissue scaffolds and drug delivery.

### CROSS REFERENCE TO RELATED APPLICATIONS

This Application claims the benefit of U.S. Provisional Application Ser. No. 61/138,441, filed Dec. 17, 2008, which is hereby incorporated by reference in its entirety.

### GOVERNMENT INTEREST STATEMENT

This invention was made in whole or in part with government support from the US Army through the Institute for Soldier Nanotechnologies (ISN) at MIT, under contract DAAD-19-02-D-0002 with the US Army Research Office. The government has certain rights in the invention.

### FIELD OF THE INVENTION

This invention is directed to fibers comprising copolymers or homopolymer blends, superstructures comprising said fibers, process for the preparation of the same and uses thereof. The fibers of this invention have long range order and superstructures produced from said fibers can be used in applications including but not limited to membranes, filtration media, optical and or conducting fibers, high surface area substrates for sensors and catalysis, stents, tissue scaffolds and drug delivery.

### BACKGROUND OF THE INVENTION

Fibers with long-range ordered internal structures have applications in various areas such as photonic band gap fibers, wearable power, sustained drug release, sensors, and multifunctional fabrics. Up to now, such fibers have been formed by melt extrusion or drawing from a macroscopic preformed rod, and were limited to relatively large diameters.

The morphologies associated with the self-assembly of molecules have long been of interest in material science. Block copolymers are well-known examples of self-assembling, amphiphilic systems that are composed of chemically distinct and usually immiscible polymer blocks that form variously shaped periodic microdomains. From both fundamental and applied points of view, block copolymers have attracted interest due to their ability to form ordered morphologies with characteristic dimensions in the range of 10-100 nm, dimensions that are hard to achieve by conventional, top-down technologies such as photolithography or extrusion. In bulk, A/B diblock copolymers form morphologies comprised of lamellae, bicontinuous cubic double gyroids, hexagonally packed cylinders or body-centered-cubic (bcc) packed spheres, depending on the copolymer molecular weight, the volumetric compositions of each polymer block and the interactions between respective monomers. When self-assembly is confined on a length scale comparable to the characteristic period of the copolymer domains, interesting new morphologies can be realized. In block copolymer thin films, the confinement effects and boundary conditions have been shown to result in either a higher degree of ordering of the phases, a change of the fundamental repeat period, or a shift of the phase boundaries between different morphologies. Additionally, external fields such as flow fields or electrical fields and lithographically defined templates can be used to direct the block copolymer self-assembly to achieve long range order.

Novel structures have been found to arise when block copolymers are confined in geometries with curved walls of dimensions (D) up to an order of magnitude larger than the bulk period (L₀) of the copolymer. In particular, cylindrical confinement has been studied both theoretically and experimentally in this regard. For example, concentric lamellar structure resembling the common myelin figure found in self-assembly of amphiphilic molecules and liquid crystals has also been observed for lamella-forming block copolymers that were confined in the nanopores of an alumina membrane. This morphology can be identified as a smectic A structure with an s=+1 disclination defect line running along the cylinder axis. This unique self-assembled structure is of particular interest in areas such as optics and drug delivery. However, the current process for producing this material—sorption into porous alumina—significantly limits the potential applications because it is an extremely slow, batch process and produces only very short “nanorods” (˜5 μm in length) after dissolution/destruction of the nanotemplate. In addition, in order to realize fully the applications of this novel structure, as is true in general for block copolymers in thin films or bulk, understanding and control of the domain sizes is essential.

An entirely different approach to self-assembly under cylindrical confinement entails the formation of long, continuous core/shell fibers using a two-fluid, coaxial electrospinning technique followed by annealing of the fibers to promote self-assembly within the block copolymer core. In recent years, electrospinning has become a popular technology for producing continuous fibers with submicron diameters from a variety of materials. Continuous fibers can be produced at rates on the order of 0.1 g (10⁶ meters) of fiber per hour per jet; the process is readily scalable to multiple jets. Potential applications of such fibers are as varied as the materials themselves, ranging from membranes and filtration media, to high surface area substrates for sensors and catalysis, to medical application such as stents, tissue scaffolds and drug delivery. Due to their small diameter, typically in the range of 10 to 1000 nm, electrospun fibers offer a novel and robust platform in which the self-assembly of block copolymers can be induced under extreme cylindrical confinement. However, the very short time scale of the fiber formation process itself does not permit the organization of blocks into a well-ordered morphology in situ, and intensive post-spin annealing of the fibers is precluded by coalescence of the fibers when held for extended periods of time above the glass transition temperatures (Tg's) or melting temperatures of the blocks. One way to overcome this problem, as shown previously, is to use a two-fluid coaxial electrospinning technique where the block copolymer is processed as the core component and encapsulated in a second, shell material that has a high T_{g} or melting temperature. Subsequent annealing of the fibers above the upper T_{g} of the block copolymer but below the corresponding glass or melting temperature of the shell material results in more nearly equilibrium self-assembly of the block copolymer under cylindrical confinement. Block copolymer core fibers can be finally obtained after the removal of the homopolymer shell.

While block copolymer ordering in electrospun fibers is known, no prior art exists demonstrating the kind of block copolymer domain ordering (“microphase separation”) relevant to the present invention, and necessary for applications ranging from membranes and filtration media, to optical or conductive fibers, to high surface area substrates for sensors and catalysis, to medical application such as stents, tissue scaffolds and drug delivery.

### SUMMARY OF THE INVENTION

In one embodiment, the present invention provides a fiber comprising a copolymer or a copolymer/homopolymer blend wherein said fiber possesses long range order selected from the list comprising concentric lamellae, cylinders, stacked disks, aligned spheres, bcc-packed spheres, fcc-packed spheres, bicontinuous gyroid, helical and double- or multi-helical structures.

In one embodiment, the present invention provides a method of manufacturing a fiber comprising the steps of: (a) formation of an initial fiber by an electrospinning process wherein said initial fiber comprises a copolymer or a copolymer/homopolymer blend; and (b) annealing of said initial fiber to form a fiber comprising long range order selected from the list comprising concentric lamellae, cylinders, stacked disks, aligned spheres, bcc-packed spheres, fcc-packed spheres, bicontinuous gyroid, helical and double- or multi-helical structures.

In one embodiment, the present invention provides a superstructure comprising a fiber wherein said fiber further comprises a copolymer or a copolymer/homopolymer blend and wherein said fiber possesses long range order selected from the list comprising concentric lamellae, cylinders, stacked disks, aligned spheres, bcc-packed spheres, fcc-packed spheres, bicontinuous gyroid, helical and double- or multi-helical structures.

In one embodiment, the present invention provides a method of preparing a superstructure comprising a fiber wherein said fiber further comprises a copolymer or a copolymer/homopolymer blend and wherein said fiber possesses long range order of structures selected from the list comprising concentric lamellae, cylinders, stacked disks, aligned spheres, bcc-packed spheres, fcc-packed spheres, bicontinuous gyroid, helical and double- or multi-helical structures.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a multi-scale view of an electrospun block copolymer fiber mat. (A) A macroscopic image of the PS-PDMS/PMAA fiber mat (scale bar=1 cm); (B) scanning electron microscopy (SEM) image of the as-spun core/shell fibers (scale bar=10 μm); (C) SEM image of the PS-PDMS core fibers after removal of the PMAA shell using methanol (same magnification as (B)). (D and E) Cross sectional transmission electron microscopy (TEM) images of the fibers after annealing, showing the core/shell structure and concentric lamellar structure in the core; in (E), the dark layers are identified to be PDMS due to its higher electron density, and the light layers are PS. The region surrounding the PS-PDMS core is the PMAA shell. (F) A tilt TEM image of a PS-PDMS core, showing a 2D projection of the 3D concentric lamellar structure. Note that the outermost PS monolayer is not resolved in this image due to the lack of sufficient contrast between PS and PMAA in this case.

FIG. 2 illustrates simulation results for the domain sizes based on a coarse-grained bead-spring model. The inset is a typical image for the concentric lamellar structure generated from the simulation. An A₅B₅ block copolymer with soft non-bond interactions enclosed in a nearly impenetrable cylindrical shell of B₁₀ homopolymer was simulated.

FIG. 3 is a schematic for a curved block copolymer interface. Compared to a flat interface, the curvature decreases the range of angles the block in the concave side is allowed to explore and therefore its conformational entropy, while it increases the range of angles available to the block on the convex side, and thus its entropy. The net entropy change for the whole chain, with the flat interface as the reference state, can be estimated as, ΔS(θ)=In [θ(2π-θ)]−In (π²), where θ depends on both the curvature and the characteristic dimension of the chain. This equation suggests that the curvature always causes an entropy loss for a symmetric block copolymer.

FIG. 4 is longitudinal TEM images of PS-PDMS in the core/shell fibers. Defects form in fibers with undulated core sizes (A and B), while fibers with nearly uniform PS-PDMS core diameters exhibit uninterrupted concentric lamellar morphology (C and D). (All images are presented at the same magnification.) Sometimes, in the vicinity of the defect core (e.g. see B), there appears to be a PDMS helical structure inside the PS core. Although the mechanism is not clear at present, similar helical structures have been observed in a cylindrical geometry near the smectic A cholesteric transition.

FIG. 5 is TEM images of a second PS-PDMS lamella-forming block copolymer (L₀=42 nm) confined in electrospun fibers and using PS-PDMS purchased from Polymer Source Inc. A and B are axial views. C-F are longitudinal views. The domain in the center is about 40% (A and C), 15% (B) and 45% (D) larger than the bulk value, and the outer domains are all slightly smaller the bulk value. In (E) and (F), 75% and 92%, respectively, of the increase in confinement size (indicated along the arrows) is absorbed by the central domain. (All images have the same magnification.)

FIG. 6 is TEM images of a lamella-forming poly(styrene-b-methyl methacrylate) (PS-PMMA) confined in electrospun fibers with PMAA as the shell. The PS-PMMA (Polymer Source Inc.) has a total molecular weight (Mw) of 79.9 kg/mol, PDI of 1.07 and PS volume fraction of about 50%. (All images are presented at the same magnification.) A, B, C and D are all different cross sections from the same fiber sample.

FIG. 7 is the total number (N) of block copolymer bilayers as a function of degree of confinement (D/L₀). The red line is a reference line based on the morphology of the unconfined bulk: N=D/L₀. The blue circles are data points from different TEM cross sections of electrospun fibers. D is defined as the diameter of the PS-PDMS component of the core/shell fibers. A representative TEM image is inserted to illustrate the structure for several specific N. (All the images are presented at the same magnification). Cross sections with an odd number of bilayers have PDMS as the central domain, while those with an even number of bilayers have PS as the central domain.

FIG. 8 is (A) Dependence of domain thickness dₙ on domain index, n, where dₙ is defined as the distance between successive AB interfaces (A=PS and B=PDMS), counting from the central domain outward, relative to that in the bulk. The outermost PS domain is a monolayer and is approximately half as thick as the other PS domains, so it is not included in the plot. (B) From left to right, schematics for block copolymer chains in bulk and in a fiber (axial view). (Note: the chain configurations drawn here are for illustrative purposes only and are not intended to represent actual or average configurations).

FIG. 9 demonstrates an embodiment of dislocation and long-range order in concentric lamellar structure. (A and B) Longitudinal views of the concentric lamellar structure near a fiber diameter transition where the number of bilayers increases by one. (Scale bar=100 nm for A and B) (C) and (D), Schematic illustrations for the radial edge dislocation with dislocation core line of nonzero and zero (effective) length, respectively. The arrow lines in panel c show a radial edge dislocation loop with the Burgers vector (b) from the start (S) to the finish (F). The Burgers vector, often denoted b, is a vector commonly used in materials science to represent the magnitude and direction of the lattice distortion of a dislocation in a crystal lattice or other ordered geometry. In the radial edge dislocation loop, b is everywhere normal to the tangent vector of the loop (t) depicting a radial edge dislocation. In panel c, two bilayers are inserted and the domains are therefore more compressed after the insertion, compared with the dislocation structure in panel d, where only one bilayer is inserted, for fibers of equal diameter. (E and F) Longitudinal views of sections of the concentric lamellar structure with no interruption. (Scale bar=100 nm for E and F.)

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

The present invention describes the encapsulation of a block copolymer in long, continuous core/shell fibers using a two-fluid, coaxial electrospinning technique followed by annealing of the fibers to promote self-assembly within the block copolymer core. The continuous, filamentary nature of these materials is novel and significant, from both science and engineering perspectives, as it offers the only form to date in which long range order along the axis of confinement is possible. Furthermore, by combining a top-down technique, electrospinning, and a bottom-up method, block copolymer self-assembly, generation of a new class of fibers and fibrous membranes with long-range ordered concentric lamellar structure that have fiber diameter 2-3 orders of magnitude smaller than those made by conventional methods is possible.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

This invention provides, in one embodiment, a fiber-based superstructure which is useful in some embodiments as a component in various devices relating to membranes and filtration media, high surface area substrates for sensors and catalysis, medical application (such as stents, tissue scaffolds and drug delivery), integrated optical circuits, fiber-optic communication devices, laparoscopic surgical instruments, externally modulated lasers (comprising distributed feedback laser diodes and electro-absorption modulators), capillary electrophoresis systems, photonic band gap fibers, wearable power devices, sensor devices, and the like.

In some embodiments, this invention provides a process of preparation of the fiber of this invention. In some embodiments, this invention provides a process of preparation of the fiber-based superstructure of this invention.

In one embodiment, this invention provides a fiber comprising a copolymer or a copolymer/homopolymer blend wherein said fiber possesses long range order selected from the list comprising concentric lamellae, cylinders, stacked disks, aligned spheres, bcc-packed spheres, fcc-packed spheres, bicontinuous gyroid, helical and double- or multi-helical structures.

In another embodiment, said copolymer is comprised of chemically dissimilar monomers. In another embodiment, said chemically dissimilar monomers give rise to phase separation.

Molecular self-assembly is the process by which molecules adopt a defined arrangement without guidance or management from an outside source. There are two types of self-assembly, intramolecular self-assembly and intermolecular self-assembly. Most often the term molecular self-assembly refers to intermolecular self-assembly (i.e. self assembly of at least two separate molecular components), while the intramolecular analog is more commonly called folding and refers to the assembly of one large molecular unit. Examples for self assembly include the formation of micelles, vesicles, liquid crystal phases, and Langmuir-Blodgett monolayers by surfactant molecules. Materials and structures with a variety of shapes and sizes can be obtained using molecular self-assembly. The diversity of the self assembled units results in a large range of molecular topologies.

In biological systems, molecular self-assembly plays a crucial role in cell function. It is evident in the self-assembly of lipids in a membrane, the formation of double helical DNA through hydrogen bonding and the assembly of proteins in quaternary structures. In one embodiment, Self-assembly is referred to as a ‘bottom-up’ manufacturing technique in contrast to a ‘top-down’ technique such as lithography where the desired final structure is carved from a larger block of matter.

In one embodiment, Self-assembly (SA) is defined as the spontaneous organization of molecular units into ordered structures by non-covalent interactions. The SA process is governed by relatively weak interactions (e.g. Van der Waals, capillary, π-π, hydrogen bonds) in contrast to covalent, ionic or metallic bonds. Although typically less energetic, these weak interactions play an important role in materials synthesis. In SA the building blocks are not only atoms and molecules, but span a wide range of nano- and/or micro-structures, with different chemical compositions, shapes and functionalities. These building blocks can be natural or can be chemically synthesized.

Examples of SA in materials science include the formation of molecular crystals, colloids, lipid bilayers, phase-separated polymers, and self-assembled monolayers. The folding of polypeptide chains into proteins and the folding of nucleic acids into their functional forms are examples of self-assembled biological structures.

In one embodiment, self-assembly is a process in which components, either separate or linked, spontaneously form ordered aggregates. The building blocks for self assembly can be molecular components, or larger sized structures of the order of nanometers to micrometers.

In one embodiment, block copolymers are comprised of two or more polymer chains that are attached to one another at one end. Block copolymers comprises polymeric chains comprising two or more components. Each component is a polymeric chain, and the monomers comprising at least two of the components differ in their chemical and/or physical characteristics. Because of the different nature of the two components, polymeric materials containing two or more components can self-assemble into supramolecular structures on length scales ranging from nanometers to microns. In a way similar to the phase separation of organic and aqueous phases, polymeric chains comprising one component will tend to aggregate and repel polymeric chains comprising a different component. As a result, regions comprising one component will be formed and these regions will be distinct from regions comprising the other component. Block copolymers can form solid or solid-like structures wherein one component or both is present in the shape of spheres, lamellae, cylinders or gyroids.

In one embodiment, block copolymers comprise two or more different monomer units, strung together in long sequences rather than randomly distributed (e.g., a diblock copolymer comprising one chain of polystyrene and one of polyisoprene). Repulsions between unlike blocks yield self-assembled mesophases having complex nanometer-scale structure, with topology and dimensions tunable through composition and molecular weight. Block copolymers of diverse chemistry can be synthesized through polymerization techniques such as anionic, ring-opening metathesis, or controlled free-radical polymerization. These materials possess rich phase behavior, since the mesophase can be altered through changes in pressure or temperature, through changes in the monomers chosen, the size of each polymer chain and the ratio between the chain lengths of the various polymers comprising the copolymer. Phase behavior can be further modified through the addition of other molecular or macromolecular components such as solvents, nanoscale particles, other polymers or block copolymers.

In one embodiment, block copolymer is a kind of a copolymer. Block copolymers are made up of blocks of different polymerized monomers. For example, PS-b-PMMA is short for polystyrene-b-poly(methyl methacrylate) and is made by first polymerizing styrene, and then subsequently polymerizing MMA from the reactive end of the polystyrene chains. This polymer is a “diblock copolymer” because it contains two different chemical blocks. Similarly, triblocks, tetrablocks, multiblocks, etc. can be synthesized.

Block copolymers can “microphase separate” to form periodic nanostructures, as in the case of some styrene-butadiene-styrene (SBS) block copolymers. Microphase separation is a situation similar to that of oil and water. Oil and water are immiscible and accordingly they separate into two phases. Due to incompatibility between the blocks, block copolymers undergo a similar phase separation. Because the blocks are covalently bonded to each other, they cannot be fully separated macroscopically as water and oil. In “microphase separation” the blocks form nanometer-sized structures. Depending on the relative lengths of each block, several morphologies can be obtained. In diblock copolymers, sufficiently different block lengths (specifically, different volume fractions of the components that make up the blocks) lead to nanometer-sized spheres of one block in a matrix of the second block (for example PMMA in polystyrene). By using less different block lengths (i.e. volume fractions), a hexagonally-packed-cylinder geometry can be obtained. Blocks of similar length (i.e. volume fraction) may form layers, often called lamellae. Between the cylindrical and lamellar phase a gyroid phase can be formed. In one embodiment, a certain degree of long range order may be found in block copolymer systems, but long range order is actually hard to achieve in block copolymers even in bulk. Some methods (e.g. flow fields, magnetic fields and lithographic patterning) have been used to induce long range order in bulk or in thin films but none of these methods involved fibers.

In one embodiment, long range order can be found in crystals or in crystalline structures. There are two main classes of solids: crystalline and amorphous. Crystalline and amorphous solids differ in their structure. In a crystal-Atomic positions exhibit a property called long-range order or translational periodicity. Long range order means that positions of atoms or molecular units repeat in space in a regular array. In an amorphous solid, translational periodicity is absent so there is no long-range order.

However, even though long range order can not be found in amorphous materials such as glass, short-range order does exist. Short range order can be interpreted as the order of the atoms bonded to a central atom in the solid. Each atom in an amorphous solid may have a few nearest-neighbor atoms at the same distance from it (called the chemical bond length), just as in the corresponding crystal. Both crystalline and amorphous solids exhibit short-range (atomic-scale) order. The well-defined short-range order is a consequence of the chemical bonding between atoms, which is responsible for holding the solid together. Most liquids lack long-range order, although many have short-range order. Short range is defined as the first- or second-nearest neighbors of an atom. In many liquids the first-neighbor atoms are arranged in the same structure as in the corresponding solid phase. At distances that are many atoms away, however, the positions of the atoms become uncorrelated. These fluids, such as water, have short-range order but lack long-range order. Solids that have short-range order but lack long-range order are called amorphous. Almost any material can be made amorphous by rapid solidification from the melt (molten state). This condition is unstable, and some solids will crystallize in time. Glasses are an example of amorphous solids.

A solid is crystalline if it has long-range order, although the term “nanocrystal” may sometimes be used to describe a solid object with crystal-like order but of very small size so that it cannot be said to have long-range order. Once the positions of an atom and its neighbors are known at one point, the place of each atom is known precisely throughout the crystal. Solid crystals have both short-range order and long-range order. Many solid materials found in nature exist in polycrystalline form rather than as a single crystal. They are actually composed of millions of grains (small crystals) packed together to fill all space. Each individual grain has a different orientation than its neighbors. Although long-range order exists within one grain, at the boundary between grains, the ordering changes direction. A typical piece of iron or copper is polycrystalline. Polycrystalline materials can be made into large single crystals after extended heat treatment.

Long range order in block copolymers may refer to the repeating size, shape and orientation of the individual blocks. In bulk, long range order can be seen for example in lamellar structures of block-copolymers wherein the thickness of each block layer is the same throughout the solid. In cylinder-forming block copolymers, the packing of the cylinders, the spacing between the cylinders and the diameters of the cylinders can have long range order and can be kept throughout the block copolymer structure or throughout portions of it. In block copolymer fibers, long range order may imply that the structure of the fiber is the same or is similar in different regions of the fibers. For example, for lamellar structure, the thickness of each layer of the two blocks is kept the same or similar throughout the length of the fiber. For fibers comprising cylinder-forming blocks, the diameter of the cylinders, the spacing between them and their packing configuration maintain long range order along the length of the fiber or along substantial portions of the fiber's length. For fibers comprising sphere-forming block copolymers, the sphere diameter, spacing between spheres and sphere-packing configuration is kept along the fiber or along portions of the fiber.

In one embodiment, the term “long range order” is used herein to describe the order of the block copolymer along fibers of the invention. In one embodiment, long range order is defined as the order of the fiber structure along the fiber. In one embodiment, the length of the long range order is at least 200 nm. In one embodiment, the length of the long range order ranges between 200 nm and the full length of the fiber. In one embodiment, the length of the long range order is at least 500 nm. In one embodiment, the length of the long range order ranges between 500 nm and the full length of the fiber. In one embodiment, the length of the long range order is at least 1 μm. In one embodiment, the length of the long range order ranges between 1 μm and the full length of the fiber. In one embodiment, μm is micrometer or micrometers.

In one embodiment, long range order of the block copolymer in the fiber means that for example if the structure of the fiber comprising the block copolymer is a concentric lamellae structure, then the cross section of the fiber will remain unchanged when looking at different segments along the fiber's length. In one embodiment, long range order means that the cross section of the fiber is the same when looking at different segments along the length of the fiber except for the addition of one or more central lamella. In one embodiment, the cross section of the fiber contains the same number of lamella along different segments of the fiber, and this number of lamella defines the long range order of the fiber. In one embodiment, the thickness of the lamella in portions of the cross section remains unchanged along the fiber, and these thickness values defines or represent the long range order along the fiber. In another embodiment, long range order represents the order of the entire cross section including the inner ⅓ or ⅔ portion of the cross section of the fiber. According to this aspect and in one embodiment, the number of lamella, the thickness of the lamella or a combination thereof remains unchanged or only slightly changes when moving along the fibers, or when cutting across different segments of the fiber. In one embodiment, slight changes in thickness of the lamella are not considered as deviations from long range order. Such slight changes can be of the order of 1% -10% or from 1%-25% of the lamella thickness. Such slight changes can be ranging between 0%-10% or between 0%-25% of the lamella thickness.

In one embodiment, the length of a fiber ranges between 1 μm and 1 cm. In one embodiment, the length of a fiber ranges between 1 μm and 100 μm. In one embodiment, the length of a fiber ranges between 1 μm and 1000 μm. In one embodiment, the length of a fiber ranges between 1 μm and 10 cm. In one embodiment, the length of a fiber ranges between 1 μm and 100 cm. In one embodiment, the length of a fiber ranges between 1 μm and 1000 cm. In one embodiment, the length of a fiber ranges between 100 μm and 1 cm. In one embodiment, the length of a fiber ranges between 10 μm and 10 cm. In one embodiment, the length of a fiber ranges between 10 μm and 100 cm. In one embodiment, the length of the fiber is at least 10 μm. In one embodiment, the length of the fiber is at least 100 μm. In one embodiment, the length of the fiber is at least 50 μm. In one embodiment, in contrast to technologies that make short “nanorods” that are microns in length, fibers of the present invention can be made essentially continuous. Fibers of this invention can be of any length desired. In one embodiment, fibers of this invention differ from nanorods. In one embodiment, fibers of this invention are much longer than nanorods.

In one embodiment, the length of the long range order ranges between 200 nm and 1 μm. In one embodiment, the length of the long range order ranges between 500 nm and 10 μm. In one embodiment, the length of the long range order ranges between 1 μm and 3 μm. In one embodiment, the length of the long range order ranges between 500 nm and 5 μm. In one embodiment, the length of the long range order ranges between 1 μm and 5 μm. In one embodiment, the length of the long range order ranges between 1 μm and 10 μm. In one embodiment, the length of the long range order ranges between 1 μm and 100 μm. In one embodiment, the length of the long range order ranges between 1 μm and 1000 μm. In one embodiment, the length of the long range order ranges between 1 μm and 1 cm. In one embodiment, the length of the long range order ranges between 1 μm and 100 μm. In one embodiment, the length of the long range order ranges between 1 μm and 1000 μm. In one embodiment, the length of the long range order ranges between 1 μm and 10 cm. In one embodiment, the length of the long range order ranges between 1 μm and 100 cm. In one embodiment, the length of the long range order ranges between 1 μm and 1000 cm. In one embodiment, the length of the long range order ranges between 100 μm and 1 cm. In one embodiment, the length of the long range order ranges between 10 μm and 10 cm. In one embodiment, the length of the long range order ranges between 10 μm and 100 cm. In one embodiment, the long range order persists through the entire length of the fiber.

In one embodiment, the long range order is long enough in range to be useful, e.g. as optical fibers. In one embodiment, long range order along the axis of the fiber is only partially lost at some point along the fiber through the introduction of radial edge dislocation loops, which can be readily quantified. Since such defects only alter the continuity of the centermost domain, fibers with multiple domains are likely to be ordered over distances very much longer than the average distance between dislocation loops. Therefore and in one embodiment, long range order exists for the centermost domain up to 1-3 μm (long range order of up to 1 μm can be seen in FIG. 4); while for outermost domains (roughly, the other ⅔ of domains in the radial direction) the order may be comparable to the length of the fiber itself (up to meters), because of the localized nature of the dislocation loop in one embodiment. In one embodiment, the only factor that limits the continuity of a domain in the outer ⅔ of the fiber periphery is the accumulation of multiple dislocation loops at the core of the fiber or occurrence of a rare dislocation loop that is not localizes to the core domain.

In one embodiment, the outermost ⅔ of domains along the fiber are continuous because the dispersity or variation of fiber diameter is typically on the order of ⅓ of average fiber diameter. Variations in fiber diameter are accommodated by dislocation loops, so only the centermost ⅓ of the fiber is likely to experience interruption of long range order due to dislocation loops. The “length” of long range order is likely to vary with the radial position of the domain, such that the outermost domains maintain long range order over the entire length of the fiber or over very long (e.g. millimeters-centimeters-meters) portions of the fiber.

As for length of ordered segment, central domains may be interrupted every 1-3 μm (quantified from frequency of observation of dislocation loops in TEMs in one embodiment), while outermost domains are essentially the length of the fiber, in one embodiment.

In one embodiment, there is no limit to the length of the fiber that can be produced; in principle, the fiber spinning operation may be run continuously, producing a single continuous filament for as long as the spinning process is stable.

In one embodiment, the length of the long range order in fibers of the invention along the fiber axis is greater than 1 μm. In one embodiment, the length of the long range order in fibers of the invention along the fiber axis is greater than 2 μm. In one embodiment, the length of the long range order in fibers of the invention along the fiber axis is greater than 3 μm. In one embodiment, the length of the long range order in fibers of the invention along the fiber axis is greater than 5 μm. In one embodiment, the length of the long range order in fibers of the invention along the fiber axis is greater than 10 μm.

In one embodiment, the number of lamellae within a fiber and the thickness of each lamellae depend on the choice (molecular weight and composition) of the block copolymer. In one embodiment, typical domain thicknesses range from d=10-100 nm, while typical fiber diameters produced by electrospinning range from D=10 nm to 10 μm. Based on these two numbers, a reasonable range for number of lamellae is Dₘᵢₙ/dₘₐₓ<1 to Dₘₐₓ/dₘᵢₙ=1000.

In one embodiment, the shell materials used in methods of this invention are flexible. In one embodiment, shell materials used in methods of this invention are flexible unlike Sol-gel materials. In one embodiment, methods of this invention make use of high Tg materials as the shell materials. In one embodiment, high Tg materials of the present invention that are used as fiber shell materials are flexible, in contrast to sol-gel based materials that may tend to form a rigid coating that is brittle and subject to fracture during subsequent attempt to anneal and handle the fibers. In one embodiment, sol-gel shells are limited to known sol-gel compositions. In contrast, Polymers with high Tg, used in methods of this invention can be chosen from a broad range of compositions. By changing the composition of the high Tg polymer, one can control which component of the block copolymer segregates to the outermost layer (PS in one embodiment as described in the examples).

In one embodiment, this invention provides a fiber comprising a copolymer or a copolymer/homopolymer blend wherein said fiber possesses long range order of structures selected from the list comprising concentric lamellae, cylinders, stacked disks, aligned spheres, bcc-packed spheres, fcc-packed spheres, bicontinuous gyroid, helical and double- or multi-helical structures.

In another embodiment, said copolymer is comprised of chemically dissimilar monomers. In another embodiment, said chemically dissimilar monomers give rise to phase separation.

In another embodiment, said chemically dissimilar monomers are selected from the list comprising styrene, isoprene, butadiene, dimethylsiloxane, methyl methacrylate, acrylonitrile, acrylic acid, ethylene oxide, caprolactone and derivatives thereof.

In another embodiment, said copolymer self-assembles into an ordered structure within said fiber. In another embodiment, self-assembly of said copolymer is directed by the chemical dissimilarity of the monomers comprising said copolymer.

In another embodiment, said fiber is encased in a shell material. In another embodiment, said shell material is selected from the list comprising poly(methyl methacrylate), poly(methacrylic acid) and poly(methacrylic acid)/poly(methyl methacrylate) copolymer.

In another embodiment, said shell material is chosen for properties selected from the list comprising reactivity with a chemical species, superhydrophobicity, oleophobicity and ease of removal from the fiber following induction of long range order. In another embodiment, said shell material is chosen for its reactivity with a chemical species. In another embodiment, said reactivity with a chemical species includes reactivity with or binding to toxic industrial chemicals. In another embodiment, said shell material is chosen for superhydrophobicity properties. In another embodiment, said shell material is chosen for oleophobicity properties. In another embodiment, said shell material is chosen for its ease of removal from the fiber following induction of long range order.

In another embodiment, said copolymer is a block copolymer. In another embodiment, said block copolymer is comprised of chemically dissimilar monomer units. In another embodiment, said chemically dissimilar monomer units are selected from the list comprising styrene, isoprene, butadiene, dimethylsiloxane, methyl methacrylate, acrylonitrile, acrylic acid, ethylene oxide, caprolactone and derivatives thereof. In another embodiment, said chemically dissimilar monomer units are arranged in 2 or more separate blocks along the length of said block copolymer.

In another embodiment, one of the blocks of said block copolymer is chosen for properties selected from the list comprising reactivity with a chemical species, superhydrophobicity, oleophobicity and ease of removal from the fiber following induction of long range order. In another embodiment, one of the blocks of said block copolymer is chosen for its reactivity with a chemical species. In another embodiment, reactivity with a chemical species includes reactivity with or binding to toxic industrial chemicals. In another embodiment, one of the blocks of said block copolymers is chosen for superhydrophobicity properties. In another embodiment, one of the blocks of said block copolymers is chosen for oleophobicity properties.

In another embodiment, said copolymer is a block copolymer and is blended with a homopolymer of the same composition as one of the copolymer blocks. In another embodiment, incorporation of said homopolymer serves to control the long range order that self-assembles within said fiber.

In another embodiment, said block copolymer is comprised of from greater than 0% to at most 50% of one of the blocks. In another embodiment, said block copolymer is comprised of from at least 25% to at most 75% of one of the blocks.

In another embodiment, said block copolymer/homopolymer blend is comprised of from greater than 0% to less than 100% of one of the blocks. In another embodiment, said block copolymer/homopolymer blend is comprised of from greater than 0% to at most 50% of one of the blocks. In another embodiment, said block copolymer/homopolymer blend is comprised of from at least 50% to less than 100% of one of the blocks. In another embodiment, said block copolymer/homopolymer blend is comprised of from at least 25% to at most 75% of one of the blocks.

In another embodiment, the monomers comprising each homopolymer of said homopolymer blend are chemically dissimilar. In another embodiment, said chemically dissimilar monomers give rise to phase separation. In another embodiment, said chemically dissimilar monomers give rise to long range ordered structure within said fiber.

In another embodiment, the diameter of said fiber is from 10-1000 nm In another embodiment, the diameter of said fiber is from 10-500 nm In another embodiment, the diameter of said fiber is from 10-250 nm. In another embodiment, the diameter of said fiber is from 500-1000 nm. In another embodiment, the diameter of said fiber is from 750-1000 nm. In another embodiment, the diameter of said fiber is from 250-750 nm.

In another embodiment, said fiber is at least 100 microns in length.

In one embodiment, the fiber comprises concentric lamellae. In one embodiment, the number of domains or lamellae ranges between 1 and 1000. In one embodiment, the number of domains or lamellae ranges between 2 and 10. In one embodiment, the number of domains or lamellae ranges between 2 and 7. In one embodiment, the number of domains or lamellae ranges between 1 and 50. In one embodiment, the number of domains or lamellae ranges between 1 and 20. In one embodiment, the number of domains or lamellae is six or seven or eight. In one embodiment, the number of domains or lamellae ranges between 50 and 150. In one embodiment, the thickness of the lamellae is uniform. In one embodiment, the thickness of the lamellae varies. In one embodiment, the thickness of the lamellae vary according to the lamella location with respect to the center of the fiber. In one embodiment, the thickness of outer lamellae are smaller than the thickness of inner or central lamella. In one embodiment, lamella thickness ranges between 10 nm and 50 nm. In one embodiment, lamella thickness ranges between 10 nm and 100 nm. In one embodiment, lamella comprising of one block have smaller thickness than lamellae formed from the other block in a di-block copolymer fibers.

In another embodiment, the long range order of said fiber persists along the length of said fiber. In another embodiment, said long range order is concentric lamellae.

In another embodiment, said fiber exhibits predominantly anisotropic electrical, magnetic or optical properties favoring transmission of electrical, magnetic or optical signals along the length of said fiber.

In one embodiment, a fiber is a filament. In one embodiment, a fiber is a thread, a strand or a yarn. In one embodiment, a fiber has a length that is at least one order of magnitude larger than the fiber's diameter. In one embodiment, a fiber has a length that is at least two orders of magnitude larger than the fiber's diameter.

In one embodiment, this invention provides a method of manufacturing a fiber comprising the steps of: (a) formation of an initial fiber by an electrospinning process wherein said initial fiber comprises a copolymer or a copolymer/homopolymer blend; and (b) annealing said initial fiber to form a fiber comprising long range order selected from the list comprising concentric lamellae, cylinders, stacked disks, aligned spheres, bcc-packed spheres, fcc-packed spheres, bicontinuous gyroid, helical and double- or multi-helical structures.

In another embodiment, the initial fiber has no long range order. In another embodiment, the initial fiber has long range order.

In another embodiment, said fiber has long range order.

In another embodiment, said initial fiber is formed by electrospinning from a first solution phase.

In another embodiment, the initial fiber is treated to form a shell on the initial fiber. In another embodiment, the material comprising the shell is chosen for properties selected from the list comprising reactivity with a chemical species, superhydrophobicity, oleophobicity and ease of removal from the fiber following induction of long range order. In another embodiment, the material comprising the shell is chosen for its reactivity with a chemical species. In another embodiment, the reactivity with a chemical species includes reactivity with or binding to toxic industrial chemicals. In another embodiment, the material comprising the shell is chosen for superhydrophobicity properties. In another embodiment, the material comprising the shell is chosen for oleophobicity properties. In another embodiment, the material comprising the shell is chosen for its ease of removal from the fiber following induction of long range order. In another embodiment, the composition of said material comprising said shell is varied so that at least one component of the copolymers adsorbs preferentially at the interface with the shell. In another embodiment, the composition of the material comprising the shell is varied so that at least one component of the homopolymer blends adsorbs preferentially at the interface with said shell.

In another embodiment, electrospinning from a first solution phase is carried out in the presence of a second solution phase. In another embodiment, said first solution phase comprises polymers of chemically dissimilar monomers selected from the list further comprising styrene, isoprene, butadiene, dimethylsiloxane, methyl methacrylate, acrylonitrile, acrylic acid, ethylene oxide, caprolactone and derivatives thereof. In another embodiment, said polymers of chemically dissimilar monomers are dissolved in a mixture of chloroform and N,N-dimethylformamide. In another embodiment, said mixture of chloroform and N,N-dimethylformamide is 100% chloroform and 0% N,N-dimethylformamide. In another embodiment, said mixture of chloroform and N,N-dimethylformamide is 75% chloroform and 25% N,N-dimethylformamide. In another embodiment, said mixture of chloroform and N,N-dimethylformamide is 50% chloroform and 50% N,N-dimethylformamide. In another embodiment, said mixture of chloroform and N,N-dimethylformamide is 25% chloroform and 75% N,N-dimethylformamide. In another embodiment, said mixture of chloroform and N,N-dimethylformamide is 0% chloroform and 100% N,N-dimethylformamide.

In another embodiment, said second solution phase comprises said shell material selected from the list further comprising poly(methyl methacrylate), poly(methacrylic acid) and poly(methacrylic acid)/poly(methyl methacrylate) copolymer. In another embodiment, said second solution phase comprises said shell material dissolved in N,N-dimethylformamide.

In another embodiment, said second solution phase serves to form a shell on said initial fiber. In another embodiment, the material comprising said shell is chosen for properties selected from the list comprising reactivity with a chemical species, superhydrophobicity, oleophobicity and ease of removal from the fiber following induction of long range order. In another embodiment, the material comprising said shell is chosen for its reactivity with a chemical species. In another embodiment, said reactivity with a chemical species includes reactivity with or binding to toxic industrial chemicals. In another embodiment, the material comprising said shell is chosen for superhydrophobicity properties. In another embodiment, the material comprising said shell is chosen for oleophobicity properties. In another embodiment, the material comprising said shell is chosen for its ease of removal from said fiber following induction of long range order. In another embodiment, the composition of said material comprising said shell is varied so that at least one component of said copolymers absorbs preferentially at the interface with said shell. In another embodiment, the composition of said material comprising said shell is varied so that at least one component of said homopolymer blends absorbs preferentially at the interface with said shell.

As shown in example 1, fibers were made using a two-fluid core/shell electrospinning, with 22 wt % PMAA in DMF as the shell fluid and 15 wt % PS-PDMS in a solvent mixture of chloroform and DMF (CHCl₃/DMF=3:1 by volume) as the core fluid. The operating parameters were as follows: voltage, 33 kV; flow rate of shell fluid 0.045 ml/min; flow rate of core fluid 0.005 ml/min; plate to plate distance 45 cm.

As shown in example 7, fibers were formed using an alternate source of PS-PDMS. Specifically, PS-PDMS (total molecular weight of 46.4 kg/mol, PDI of 1.08 and PS volume fraction of about 50%; purchased from Polymer Source Inc.) was electrospun into fibers using similar conditions to those described in Example 1. Specifically, for this PS-PDMS, 22 wt % PMAA in DMF was used as the shell fluid and 18 wt % PS-PDMS in a solvent mixture of chloroform and DMF (CHCl₃/DMF=3:1 by volume) was used as the core fluid. The operating parameters were as follows: voltage, 35 kV; flow rate of shell fluid 0.05 ml/min; flow rate of core fluid 0.004 ml/min; plate to plate distance 50 cm.

TEM images of the resulting fibers are shown in FIG. 5. Using this copolymer, the unique behavior for the central domain was confirmed to be independent of the copolymer molecular weight. By comparing FIGS. 1, 4, 5 and 6, this example also demonstrates that the domain sizes can be easily tuned by adjusting the copolymer molecular weight.

Prior to examination, fibers were microtomed as shown in example 9. Specifically, electrospun fibers were annealed at 180° C. for 5 days before they were microtomed, stained with ruthenium tetraoxide (RuO₄) and examined using TEM. The annealed fibers were first embedded in epoxy resin (LR White-Medium Grade, Ladd Research) and microtomed into ˜70 nm thick sections at room temperature. The thin sections were transferred onto TEM grids and stained by placing them above a 0.5 wt % ruthenium tetroxide aqueous solution for about 15 minutes. The selectively stained PS domains appear dark, while the unstained PMMA domains are lighter. The outermost PS layers have approximately the same (rather than half) thickness as those interior PS layers, indicating that PMMA actually comprises the outermost domains, but these outermost domains are not resolved in the images due to the low contrast between PMMA and the surrounding PMAA shell. This is in direct contrast to the case of PS-PDMS block copolymers, where PS is always the outermost layer, but consistent with the preferred interaction of PMMA with PMAA (χ_{PS/PMAA}=0.14; χ_{PMMA/PMAA}=0.004 at 180° C.). This example demonstrates that the effect of the interaction between the confining material and block copolymer on its phase structure can be explored; both the chemical and physical properties of the concentric lamellar morphology can be tailored in more detail.

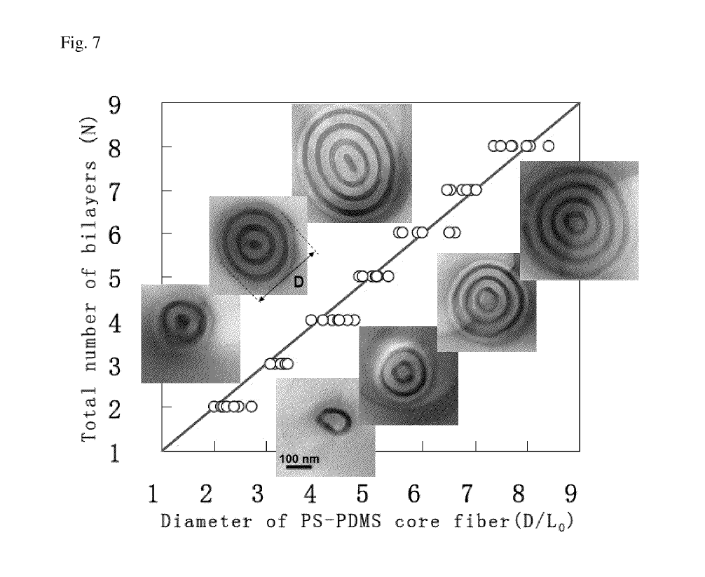

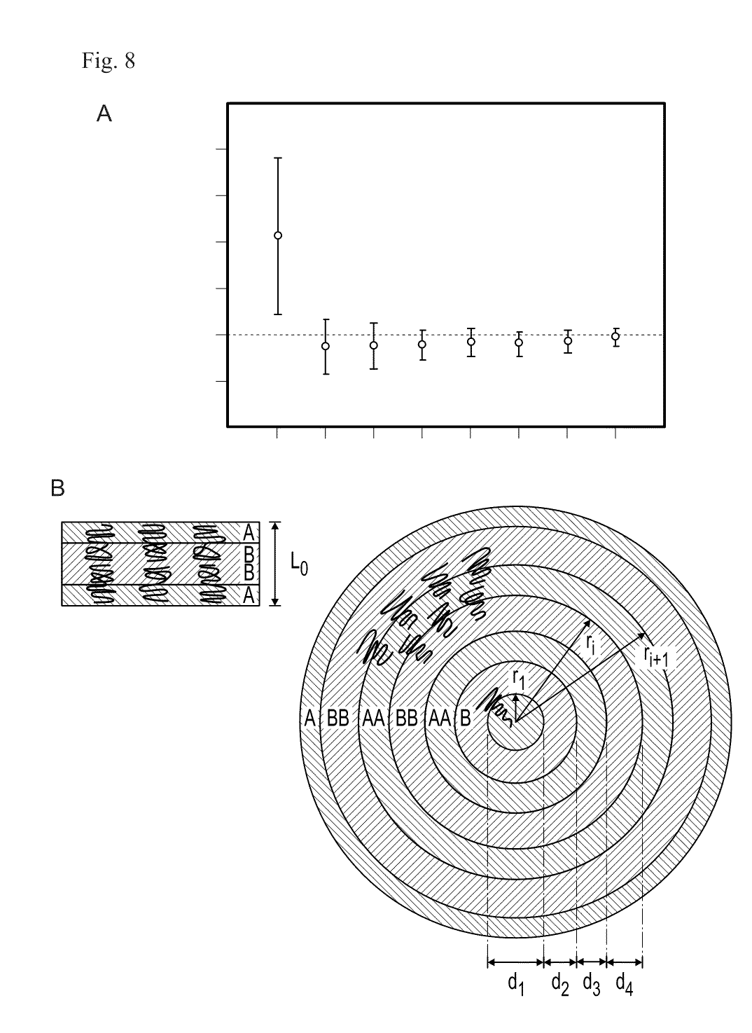

As shown in example 2, the electrospun fibers of example 1 were observed using a JEOL-6060SEM (JEOL Ltd, Japan) scanning electron microscope (SEM) after the fibers were sputter-coated with a 2-3 nm layer of gold using a Desk II cold sputter/etch unit (Denton Vacuum LLC, NJ). To view their internal structures, the annealed fibers were first embedded in epoxy resin (LR White-Medium Grade, Ladd Research) and cryo-microtomed (see Example 9) into ˜70 nm thick sections using a diamond knife (Diatome AG) on a microtome device (Leica EM UC6). The unannealed fibers have block copolymer structures far from equilibrium and are therefore not investigated. The cutting temperature was set at −160° C., lower than the T_{g} of PS (105° C.) or PDMS (−120° C.), to minimize distortions of microdomains during the microtoming The cross sections were then examined using a JEOL JEM200 CX (JEOL Ltd, Japan) transmission electron microscope (TEM) operated at an accelerating voltage of 200 kV. Since the electron density of the PDMS block is sufficiently high to provide the necessary mass thickness contrast over the PS block, no staining was needed. TEM images of PS-PDMS fibers are shown in FIGS. 1, 4, 5, 6 and 9. As illustrated in FIG. 7, the total number (N) of block copolymer bilayers is a function of degree of confinement (D/L₀). Furthermore, as shown in FIG. 8, the domain thickness is dependent upon the domain index.

In another embodiment, said initial fiber is formed by electrospinning from a first melt phase. In another embodiment, said first melt phase comprises a polymer of chemically dissimilar monomers selected from the list further comprising styrene, isoprene, butadiene, dimethylsiloxane, methyl methacrylate, acrylonitrile, acrylic acid, ethylene oxide, caprolactone, alkanes, alkenes, alkynes and derivatives thereof.

In another embodiment, said initial fiber is treated to form a shell on said initial fiber. In another embodiment, the material comprising said shell is chosen for properties selected from the list comprising reactivity with a chemical species, superhydrophobicity, oleophobicity and ease of removal from the fiber following induction of long range order. In another embodiment, the material comprising said shell is chosen for its reactivity with a chemical species. In another embodiment, said reactivity with a chemical species includes reactivity with or binding to toxic industrial chemicals. In another embodiment, the material comprising said shell is chosen for superhydrophobicity properties. In another embodiment, the material comprising said shell is chosen for oleophobicity properties. In another embodiment, the material comprising said shell is chosen for its ease of removal from the fiber following induction of long range order. In another embodiment, the composition of said material comprising said shell is varied so that at least one component of said copolymers absorbs preferentially at the interface with said shell. In another embodiment, the composition of said material comprising said shell is varied so that at least one component of said homopolymer blends absorbs preferentially at the interface with said shell.

In another embodiment, electrospinning from a first melt phase is carried out in the presence of a second melt phase. In another embodiment, said second melt phase comprises material having a higher melting temperature or glass transition temperature than the first melt phase. In another embodiment, said second melt phase serves to form a shell on said initial fibers. In another embodiment, the material comprising said shell is chosen for properties selected from the list comprising reactivity with a chemical species, superhydrophobicity, oleophobicity and ease of removal from the fiber following induction of long range order. In another embodiment, the material comprising said shell is chosen for its reactivity with a chemical species. In another embodiment, said reactivity with a chemical species includes reactivity with or binding to toxic industrial chemicals. In another embodiment, the material comprising said shell is chosen for superhydrophobicity properties. In another embodiment, the material comprising said shell is chosen for oleophobicity properties. In another embodiment, the material comprising said shell is chosen for its ease of removal from said fiber following induction of long range order. In another embodiment, the composition of said material comprising said shell is varied so that at least one component of said copolymer absorbs preferentially at the interface with said shell. In another embodiment, the composition of said material comprising said shell is varied so that at least one component of said copolymer/homopolymer blend absorbs preferentially at the interface with said shell.

In another embodiment, annealing of said initial fiber to form said fiber induces self-assembly of said initial fiber into an ordered structure. In another embodiment, annealing of said initial fiber to form said fiber is chemical or thermal annealing. In another embodiment, annealing of said initial fiber to form said fiber is chemical annealing. In another embodiment, said chemical annealing comprises a chemical annealing agent capable of plasticizing said copolymer without plasticizing said shell material. In another embodiment, annealing of said initial fibers to form said fiber is thermal annealing.

In another embodiment, said copolymer is comprised of chemically dissimilar monomers. In another embodiment, said copolymer self-assembles into ordered structures within said fiber. In another embodiment, self-assembly of said copolymer is directed by the chemical dissimilarity of the monomers comprising said copolymer.

In another embodiment, said copolymer is a block copolymer. In another embodiment, said block copolymer is comprised of chemically dissimilar monomer units. In another embodiment, said chemically dissimilar monomer units are arranged in 2 or more separate blocks along the length of said block copolymer. In another embodiment, one of the blocks of said block copolymers is chosen for properties selected from the list comprising reactivity with a chemical species, superhydrophobicity, oleophobicity and ease of removal from the fiber following induction of long range order. In another embodiment, one of the blocks of said block copolymers is chosen for its reactivity with a chemical species. In another embodiment, said reactivity with a chemical species includes reactivity with or binding to toxic industrial chemicals. In another embodiment, one of the blocks of said block copolymers is chosen for superhydrophobicity properties. In another embodiment, one of the blocks of said block copolymers is chosen for oleophobicity properties.

In another embodiment, said copolymer is a block copolymer and is blended with a homopolymer. In another embodiment, incorporation of said homopolymer serves to control the long range order that self-assembles within said fiber. In another embodiment, said block copolymer is comprised of from greater than 0% to at most 50% of one of the blocks. In another embodiment, said block copolymer is comprised of from at least 25% to at most 75% of one of the blocks.

In another embodiment, said block copolymer/homopolymer blend is comprised of from greater than 0% to at most 50% of one of the blocks. In another embodiment, said block copolymer/homopolymer blend is comprised of from at least 25% to at most 75% of one of the blocks.

In one embodiment, percentage of one of the blocks as described above means or is referring to volume fraction, weight percentage, molar percentage, number of monomeric units, or percentage of any amount or property of polymer that can be assigned to the two blocks or each of the polymers in a copolymer or in a polymeric blend.

In another embodiment, the monomers comprising each homopolymer of said homopolymer blend are chemically dissimilar. In another embodiment, said chemically dissimilar monomers give rise to phase separation. In another embodiment, said chemically dissimilar monomers give rise to long range ordered structure within said fiber.

In another embodiment, the diameter of said fiber is from 10-1000 nm. In another embodiment, the diameter of said fiber is from 10-500 nm. In another embodiment, the diameter of said fiber is from 10-250 nm. In another embodiment, the diameter of said fiber is from 500-1000 nm. In another embodiment, the diameter of said fiber is from 750-1000 nm. In another embodiment, the diameter of said fiber is from 250-750 nm.

In another embodiment, said fiber is at least 100 microns in length.

In another embodiment, the long range order of said fiber persists along the length of said fiber. In another embodiment, said long range order is concentric lamellae.

In another embodiment, said fiber exhibits predominantly anisotropic electrical, magnetic or optical properties favoring transmission of electrical, magnetic or optical signals along the length of said fiber.

Theoretical characterization of fiber domain sizes were established via computer simulation. As shown in example 6, chain density corresponding to approximately 20 kg/mol polystyrene melt was used to attain a realistic degree of thermal fluctuations, and interaction parameters were chosen in the intermediate segregation regime, where segregation was reliable but interfaces were still wide relative to monomer dimensions. The block copolymer and homopolymer in the system were allowed to interpenetrate to a depth comparable to monomer dimensions to attenuate density artifacts of the walls.

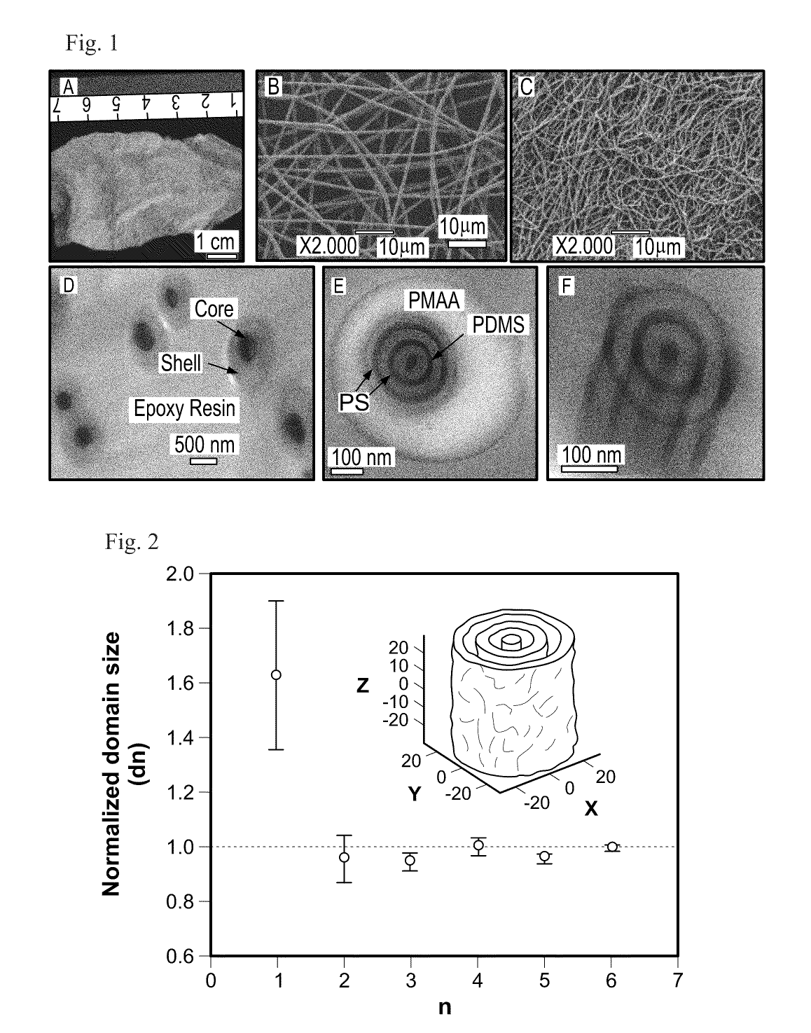

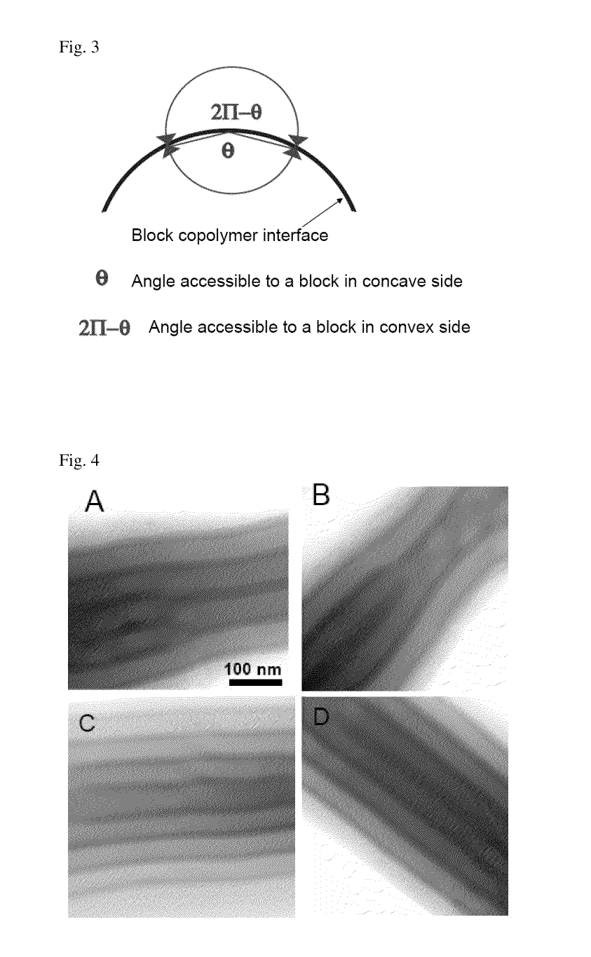

The simulation results, illustrated in FIG. 2, confirm that the significant difference between the central domain and outer domains are not due to the polydispersity of the block copolymer. Furthermore, these results are consistent with the schematic for a curved block copolymer interface illustrated in FIG. 3.

Computer simulations were performed using the Molecular Dynamics method with a bead-spring model of the block copolymer that includes bonded interactions for chain connectivity, homogeneous nonbonded interactions to reflect compressibility, and inhomogeneous nonbonded interactions to capture immiscibility between beads of different types. Confinement within a cylindrical geometry was mimicked using a soft boundary constraint. The simulation results indicate that long range order is a consequence of the unique behavior of the central domain in these fibers.

Electrospun fibers were characterized using two methods of image analysis. In the first method, show in example 3, transmission intensity values were read along a diameter of the cross section and domain boundaries were visually identified as sharp changes in intensity. The diameter for each image was selected manually, along the narrowest dimension of the cross section to mitigate the artifacts of non-perpendicular microtoming.

In the second method of image analysis, shown in example 4, complete boundaries between homogeneous regions in the logarithm of transmission intensity distribution were obtained using the region competition algorithm of Zhu and Yuille. Background subtraction and some smoothing were necessary to obtain robust performance. This algorithm finds the edges that optimally separate the image into regions, where pixel intensities are generated by the same probability distribution; here, however, the regions were forced to have concentric topology. The radius of each PS-PDMS interface was determined as that of a circle with the area equivalent to the area enclosed by the interface; domain sizes were calculated based on these radii.

In one embodiment, this invention provides a superstructure comprising a fiber wherein said fiber further comprises a copolymer or copolymer/homopolymer blend and wherein said fiber possesses long range order selected from the list comprising concentric lamellae, cylinders, stacked disks, aligned spheres, bcc-packed spheres, fcc-packed spheres, bicontinuous gyroid, helical and double- or multi-helical structures.

In another embodiment, said superstructure is a membrane, a thread, a yarn, a cable or another superstructure comprising said fibers. In another embodiment, said superstructure is a membrane. In another embodiment, said membrane is comprised of woven said fibers. In another embodiment, said membrane is comprised of non-woven said fibers. In another embodiment, said superstructure is a thread. In another embodiment, said superstructure is a yarn. In another embodiment, said superstructure is a cable.

In another embodiment, said copolymer is comprised of chemically dissimilar monomers.

In another embodiment, said copolymer self-assembles into an ordered structure within said fiber. In another embodiment, self-assembly of said copolymer is directed by the chemical dissimilarity of the monomers comprising said copolymer.

In another embodiment, said fiber is encased in a shell material. In another embodiment, said shell material is chosen for properties selected from the list comprising reactivity with a chemical species, superhydrophobicity, oleophobicity, and ease of removal from the fiber following induction of long range order. In another embodiment, said shell material is chosen for its reactivity with a chemical species. In another embodiment, said reactivity with a chemical species includes reactivity with or binding to toxic industrial chemicals. In another embodiment, said shell material is chosen for superhydrophobicity properties. In another embodiment, said shell material is chosen for its ease of removal from the fiber following induction of long range order.

In another embodiment, said copolymer is a block copolymer, comprised of chemically dissimilar monomer units. In another embodiment, said chemically dissimilar monomer units are arranged in 2 or more separate blocks along the length of said block copolymer. In another embodiment, one of the blocks of said block copolymer is chosen for properties selected from the list comprising reactivity with a chemical species, superhydrophobicity and oleophobicity. In another embodiment, one of the blocks of said block copolymer is chosen for its reactivity with a chemical species. In another embodiment, said reactivity with a chemical species includes reactivity with or binding to toxic industrial chemicals. In another embodiment, one of the blocks of said block copolymer is chosen for superhydrophobicity properties. In another embodiment, one of the blocks of said block copolymer is chosen for oleophobicity properties.

In another embodiment, said copolymer is a block copolymer and is blended with a homopolymer. In another embodiment, incorporation of said homopolymer serves to control the long range order that self-assembles within said fiber.

In another embodiment, said block copolymer is comprised of from greater than 0% to at most 50% of one of the blocks. In another embodiment, said block copolymer is comprised of from at least 25% to at most 75% of one of the blocks.

In another embodiment, said block copolymer/homopolymer blend is comprised of from greater than 0% to at most 50% of one of the blocks. In another embodiment, said block copolymer/homopolymer blend is comprised of from at least 25% to at most 75% of one of the blocks.

In another embodiment, the monomers comprising each homopolymer of said homopolymer blend are chemically dissimilar. In another embodiment, said chemically dissimilar monomers give rise to phase separation. In another embodiment, said chemically dissimilar monomers give rise to long range ordered structure within said fibers.

In another embodiment, the diameter of said fiber is from 10-1000 nm. In another embodiment, the diameter of said fiber is from 10-500 nm. In another embodiment, the diameter of said fiber is from 10-250 nm. In another embodiment, the diameter of said fiber is from 500-1000 nm. In another embodiment, the diameter of said fiber is from 750-1000 nm. In another embodiment, the diameter of said fiber is from 250-750 nm.

In another embodiment, said fiber is at least 100 microns in length.

In another embodiment, the long range order of said fiber persists along the length of said fiber. In another embodiment, said long range order is concentric lamellae.

In another embodiment, said fiber exhibit predominantly anisotropic electrical, magnetic or optical properties favoring transmission of electrical, magnetic or optical signals along the length of said fiber.

In one embodiment, this invention provides a method of preparing a superstructure comprising a fiber wherein said fiber further comprises a copolymer or a copolymer/homopolymer blend and wherein said fiber possesses long range order selected from the list comprising concentric lamellae, cylinders, stacked disks, aligned spheres, bcc-packed spheres, fcc-packed spheres, bicontinuous gyroid, helical and double- or multi-helical structures.

In another embodiment, said fiber is pressed into a membrane. In another embodiment, said fiber is aligned with an adjacent said fiber. In another embodiment, said fiber is not aligned with an adjacent said fiber.

In another embodiment, said fiber is woven into a membrane.

In another embodiment, said fiber is spun into a thread. In another embodiment, said thread is spun into a cable. In another embodiment, said thread is woven into a cable.

In another embodiment, said fiber is spun into a yarn. In another embodiment, said fiber is spun into a cable. In another embodiment, said fiber is woven into a cable.

As shown in example 5, a mat composed of the PS-PDMS/PMAA core/shell electrospun fibers was prepared and the ordered structure formed upon annealing is shown in FIG. 1. The fibers were made using a two-fluid core/shell electrospinning, with 22 wt % PMAA in dimethylformamide (DMF) as the shell fluid and 15 wt % PS-PDMS in a solvent mixture of chloroform and DMF (CHCl₃/DMF=3:1 by volume) as the core fluid. For the data shown here, the operating parameters were as follows: voltage, 33 kV; flow rate of shell fluid, 0.045 ml/min; flow rate of core fluid, 0.005 ml/min; plate to plate distance, 45 cm. Long continuous fibers of PS-PDMS (FIG. 1C) can be produced by removal of the PMAA shell using methanol as the selective solvent. The average diameter of the as-spun core/shell fibers is 800±150 nm, while that of the PS-PDMS fibers is 300±220 nm after removal of the shell. Well-defined concentric lamellar structure is formed within the fiber core, as shown by FIG. 1, D-F. FIG. 1E also shows that the PS block preferentially segregates to the core/shell interface with PMAA due to its lower Flory interaction parameter (χ_{PS/PMAA}=0.14 at 160° C.) compared to that of PDMS with PMAA (χ_{PDMS/PMAA}=0.72 at 160° C.). As expected, this PS monolayer is approximately half as thick as the inner PS domains, which are bilayers.

In another embodiment, said copolymer is comprised of chemically dissimilar monomers.

In another embodiment, said copolymer self-assembles into an ordered structure within said fiber. In another embodiment, self-assembly of said copolymer is directed by the chemical dissimilarity of the monomers comprising said copolymer.

In another embodiment, said fiber is encased in a shell material. In another embodiment, said shell material is chosen for properties selected from the list comprising reactivity with a chemical species, superhydrophobicity, oleophobicity and ease of removal from the fiber following induction of long range order. In another embodiment, said shell material is chosen for its reactivity with a chemical species. In another embodiment, said reactivity with a chemical species includes reactivity with or binding to toxic industrial chemicals. In another embodiment, said shell material is chosen for superhydrophobicity properties. In another embodiment, said shell material is chosen for oleophobicity properties. In another embodiment, said shell material is chosen for its ease of removal from the fiber following induction of long range order.

In another embodiment, said copolymer is a block copolymer, comprised of chemically dissimilar monomer units. In another embodiment, said chemically dissimilar monomer units are arranged in 2 or more separate blocks along the length of said block copolymer. In another embodiment, one of the blocks of said block copolymer is chosen for properties selected from the list comprising reactivity with a chemical species, superhydrophobicity and oleophobicity. In another embodiment, one of the blocks of said block copolymer is chosen for its reactivity with a chemical species. In another embodiment, said reactivity with a chemical species includes reactivity with or binding to toxic industrial chemicals. In another embodiment, one of the blocks of said block copolymer is chosen for superhydrophobicity properties. In another embodiment, one of the blocks of said block copolymer is chosen for oleophobicity properties.

In another embodiment, said copolymer is a block copolymer and is blended with a homopolymer. In another embodiment, incorporation of said homopolymer serves to control the long range order that self-assembles within said fiber.

In another embodiment, said block copolymer is comprised of from greater than 0% to at most 50% of one of the blocks. In another embodiment, said block copolymer is comprised of from at least 25% to at most 75% of one of the blocks.

In another embodiment, said block copolymer/homopolymer blend is comprised of from greater than 0% to at most 50% of one of the blocks. In another embodiment, said block copolymer/homopolymer blend is comprised of from at least 25% to at most 75% of one of the blocks.

In another embodiment, the monomers comprising each homopolymer of said copolymer/homopolymer blend are chemically dissimilar. In another embodiment, said chemically dissimilar monomers give rise to phase separation. In another embodiment, said chemically dissimilar monomers give rise to long range ordered structure within said fiber.

In another embodiment, the diameter of said fiber is from 10-1000 nm. In another embodiment, the diameter of said fiber is from 10-500 nm. In another embodiment, the diameter of said fiber is from 10-250 nm. In one embodiment, the diameter of said fiber is from 750-1000 nm. In another embodiment, the diameter of said fiber is from 250-750 nm.

In another embodiment, said fiber is at least 100 microns in length.

In another embodiment, the long range order of said fiber persists along the length of said fiber. In another embodiment, said long range order is concentric lamellae.

In one embodiment, this invention provides an electronic device comprising a superstructure further comprising a fiber wherein said fiber further comprises a copolymer or a copolymer/homopolymer blend and wherein said fiber possesses long range order of structures selected from the list comprising concentric lamellae, cylinders, stacked disks, aligned spheres, bcc-packed spheres, fcc-packed spheres, bicontinuous gyroid, helical and double- or multi-helical structures. In another embodiment, said superstructure is a membrane, a thread, a yarn, a cable or another superstructure comprising a said fiber. In another embodiment, said superstructure is a membrane. In another embodiment, said membrane is comprised of a woven said fiber. In another embodiment, said membrane is comprised of a non-woven said fiber. In another embodiment, said superstructure is a thread. In another embodiment, said superstructure is a yarn. In another embodiment, said superstructure is a cable.

In another embodiment, said electronic device is an integrated optical circuit useful for integrating multiple photonic functions. In another embodiment, said integrated optical circuit is a component of a fiber-optic communication device. In another embodiment, said integrated optical circuit is a component of a laparoscopic surgical instrument. In another embodiment, said integrated optical circuit is an externally modulated laser comprising a distributed feedback laser diode and an electro-absorption modulator.

In one embodiment, this invention provides a capillary electrophoresis system comprising a superstructure further comprising a fiber wherein said fiber further comprises a copolymer or a copolymer/homopolymer blend and wherein said fiber possesses long range order of structures selected from the list comprising concentric lamellae, cylinders, stacked disks, aligned spheres, bcc-packed spheres, fcc-packed spheres, bicontinuous gyroid, helical and double- or multi-helical structures. In another embodiment, said superstructure is a membrane, a thread, a yarn, a cable or another superstructure comprising a said fiber. In another embodiment, said superstructure is a membrane. In another embodiment, said membrane is comprised of a woven said fiber. In another embodiment, said membrane is comprised of a non-woven said fiber. In another embodiment, said superstructure is a thread. In another embodiment, said superstructure is a yarn. In another embodiment, said superstructure is a cable. In another embodiment, said superstructure functions as a photonic band gap fiber.

In one embodiment, this invention provides a power generation unit comprising a superstructure further comprising a fiber wherein said fiber further comprise a copolymer or a copolymer/homopolymer blend and wherein said fiber possesses long range order of structures selected from the list comprising concentric lamellae, cylinders, stacked disks, aligned spheres, bcc-packed spheres, fcc-packed spheres, bicontinuous gyroid, helical and double- or multi-helical structures. In another embodiment, said superstructure is a membrane, a thread, a yarn, a cable or another superstructure comprising said fibers. In another embodiment, said superstructure is a membrane. In another embodiment, said membrane is comprised of a woven said fiber. In another embodiment, said membrane is comprised of a non-woven said fiber. In another embodiment, said superstructure is a thread. In another embodiment, said superstructure is a yarn. In another embodiment, said superstructure is a cable.

In another embodiment, said power generation unit is selected from the list comprising a battery, a capacitor, a photovoltaic device and the like. In another embodiment, said power generation unit is a battery. In another embodiment, said power generation unit is incorporated into a wearable composition. In another embodiment, said wearable composition is selected from the list comprising a shirt, a jacket, a hat, an armband, a necklace and the like.

In one embodiment, this invention provides a sensor device comprising a superstructure further comprising a fiber wherein said fiber further comprises a copolymer or a copolymer/homopolymer blend and wherein said fiber possesses long range order of structures selected from the list comprising concentric lamellae, cylinders, stacked disks, aligned spheres, bcc-packed spheres, fcc-packed spheres, bicontinuous gyroid, helical and double- or multi-helical structures. In another embodiment, said superstructure is a membrane, a thread, a yarn, a cable or another superstructure comprising a said fiber. In another embodiment, said superstructure is a membrane. In another embodiment, said membrane is comprised of a woven said fiber. In another embodiment, said membrane is comprised of a non-woven said fiber. In another embodiment, said superstructure is a thread. In another embodiment, said superstructure is a yarn. In another embodiment, said superstructure is a cable. In another embodiment, said sensor device detects chemical agents, biological agents, trace organic vapors, binding of proteins from solution and the like.

In one embodiment, this invention provides an implantable drug-eluting device comprising a superstructure further comprising a fiber wherein said fiber further comprises a copolymer or a copolymer/homopolymer blend and wherein said fiber possesses long range order of structures selected from the list comprising concentric lamellae, cylinders, stacked disks, aligned spheres, bcc-packed spheres, fcc-packed spheres, bicontinuous gyroid, helical and double- or multi-helical structures. In another embodiment, said superstructure is a membrane, a thread, a yarn, a cable or another superstructure comprising a said fiber. In another embodiment, said superstructure is a membrane. In another embodiment, said membrane is comprised of a woven said fiber. In another embodiment, said membrane is comprised of a non-woven said fiber. In another embodiment, said superstructure is a thread. In another embodiment, said superstructure is a yarn. In another embodiment, said superstructure is a cable.

In another embodiment, said implantable drug-eluting device is selected from the list comprising a stent, a wafer, a membrane and the like. In another embodiment, said implantable drug-eluting device delivers a controlled sustained release of pharmaceutical agents. In another embodiment, said implantable drug-eluting device delivers one or more pharmaceutical agents selected from the list comprising immunosuppressants, contraceptives, insulin, diabetes therapeutics, Alzheimer's disease therapeutics, antibiotics, anti-inflammatory agents, antihypertensive agents, antithrombotic agents and the like.

In another embodiment, one or more pharmaceutical agents are incorporated into at least one of the two phases comprising a said fiber further comprising a copolymer or a copolymer/homopolymer blend wherein said fiber possesses long range order of structures selected from the list comprising concentric lamellae, cylinders, stacked disks, aligned spheres, bcc-packed spheres, fcc-packed spheres, bicontinuous gyroid, helical and double- or multi-helical structures.

In one embodiment, with respect to formation of fibers with long-range radial and axial order of this invention, the important question is the mechanism by which the concentric lamellar morphology is interrupted and defects are formed as the number of domains in the radial direction varies along the length of the fiber. The unique behavior of the central domain in fibers of the invention offers some insight into this question. Taking advantage of the long continuous nature of electrospun fibers, transitions in the nature of the domain morphology as the diameter of the PS-PDMS core fiber varies, can be located and examined FIG. 10a,b show two representative longitudinal views of the concentric lamellar structure near these transitions. On the basis of frequency of observation over a large number of TEM images, such transitions almost always involve the conversion of the central domain from A to B or B to A on the axis of the fiber.

On the basis of this, several important observations can be made. First, for a given number of domains, as the diameter D of the core fiber undulates very gradually along the length of a fiber (e.g., as indicated by the arrow in FIG. 10a), the small variations in diameter are absorbed almost entirely by the central domain, while the thickness of the outer domains stay approximately the same. This is evident in the plot in FIG. 9a, where the central domain is shown to have a much larger variation in thickness than the outer ones. Second, when the diameter of the core fiber increases sufficiently, an additional domain inserts within the overly expanded central domain to relax the unusually large stress experienced by that domain. This phenomenon is very similar to the formation of an edge dislocation in smectic A liquid crystals. Taken in cross section (FIG. 10c), the edge dislocation can be identified by the Burgers vector (b) oriented radially and orthogonal to the dislocation core tangent line vector (t); the dislocation core itself is curved, and describes a circumferential loop that closes upon itself. This is termed here a “radial edge dislocation loop”. The fact that the direction of the Burgers vector of the dislocation varies is a consequence of the presence of the s=+1 disclination line defect along the fiber axis. In the limit that the dislocation core is confined to the central domain, as shown in FIG. 10d, the loop itself is singular. This type of defect is expected to be energetically more favorable than the one in FIG. 10c because the dislocation loop is shorter in length and the associated excess strain energy should be less. Finally, and most importantly, the defect tends to be localized around the central domain; that is, all domains except the central one remain continuous without interruption over macroscopic length scales. Indeed, 1 μm long sections of defect-free fiber, where even the central domain is uninterrupted, are readily observed by TEM (FIG. 10e,f), indicating that such defects are relatively rare. On the basis of frequency of observation and the slow modulation of fiber diameter, an average defect spacing along the fiber axis of about 1-3 μm is expected in fibers of the invention in one embodiment. This spacing can be modified through control of the block copolymer fiber core diameter during fabrication.

In one embodiment, long continuous fibers having concentric lamellar morphology and long-range order have been achieved by the fabrication of core-shell nanofibers, using two-fluid coaxial electrospinning, followed by confined self-assembly of a PS-PDMS block copolymer within the core. The cylindrical confining geometry is shown to alter the domain sizes of lamella-forming block copolymers in a way that is remarkably different from confined thin films, where the period is constant across the film thickness. In the cylindrical geometry, the central domain is much (˜40% on average) larger than the bulk value, yet smaller than the value estimated by assuming interfacial chain density equivalent to bulk; the outer domains are slightly (<10%) smaller than the bulk value. The thickness of both the central and outer domains can be explained by a reduction in interfacial chain density imposed by the curvature of the intermaterial dividing surfaces (IMDS) associated with the cylindrical geometry. The study also shows that radial edge dislocation loops may form to accommodate variations in the core fiber size with the outer domains remaining continuous and ordered over long lengths of fiber; this long-range order can be improved through tight control of fiber core size (e.g., by adjusting the solution properties and optimizing the operating parameters in electrospinning).

The availability of this new class of continuous nanofibers having coherent, long ranged order, as shown by the results reported herein, create numerous opportunities for further studies of both fundamental and practical nature. For example and in one embodiment, there exists considerable freedom to control both the structural properties (e.g., domain sizes) by adjusting the molecular weight of the copolymer and the chemical nature of the material by simply choosing different core diblock or shell homopolymer compositions. These can in principle be used to modulate the stability and frequency of radial edge dislocation loops within the fibers. Understanding and control of these aspects of self-assembly under cylindrical confinement could lead to a tremendous expansion above and beyond the current list of applications for continuous nanofibers.

The following examples are presented in order to more fully illustrate the preferred embodiments of the invention. They should in no way, however, be construed as limiting the broad scope of the invention.

### EXAMPLES

For demonstration purposes, a poly(styrene-b-dimethylsiloxane) (PS-PDMS) block copolymer (provided by Randal M. Hill—custom synthesis) was chosen as the core component and a poly(methacrylic acid) (PMAA) was used as the shell. PMAA has a glass transition temperature (T_{g}) of 220° C., much higher than that of polystyrene (PS; 105° C.) or polydimethylsiloxane (PDMS; −120° C.); in the presence of the PMAA shell, fiber dimensions remain unchanged upon annealing at 160° C. for 10 days under vacuum. The PS-PDMS copolymer has a total molecular weight (Mw) of 93.4 kg/mol and polydispersity index (pdi) of 1.04, and forms a lamellar morphology in bulk with a period (L₀) of 56 nm.

In the following examples, the PS-PDMS block copolymer was custom synthesized using anionic polymerization. The characterization of molecular weight was performed using size exclusion chromatography (SEC) and membrane osmometry (MO). The PMAA polymer was purchased from Scientific Polymer Products, Inc. (catalog no. 709). The solvents, dimethylformamide (DMF) and chloroform, were purchased from Sigma-Aldrich Co. and used as received.

### Example 1

### Formation of Fibers Using Electrospinning

The fibers were made using a two-fluid core/shell electrospinning, with 22 wt % PMAA in DMF as the shell fluid and 15 wt % PS-PDMS in a solvent mixture of chloroform and DMF (CHCl₃/DMF=3:1 by volume) as the core fluid. The operating parameters were as follows: voltage, 33 kV; flow rate of shell fluid 0.045 ml/min; flow rate of core fluid 0.005 ml/min; plate to plate distance 45 cm.

### Example 2

### Characterization of Fibers Formed Using Electrospinning

The electrospun fibers were observed using a JEOL-6060SEM (JEOL Ltd, Japan) scanning electron microscope (SEM) after the fibers were sputter-coated with a 2-3 nm layer of gold using a Desk II cold sputter/etch unit (Denton Vacuum LLC, NJ). To view their internal structures, the annealed fibers were first embedded in epoxy resin (LR White-Medium Grade, Ladd Research) and cryo-microtomed (see Example 9) into ˜70 nm thick sections using a diamond knife (Diatome AG) on a microtome device (Leica EM UC6). The unannealed fibers have block copolymer structures far from equilibrium and are therefore not investigated. The cutting temperature was set at −160° C., lower than the T_{g} of PS (105° C.) or PDMS (−120° C.), to minimize distortions of microdomains during the microtoming The cross sections were then examined using a JEOL JEM200 CX (JEOL Ltd, Japan) transmission electron microscope (TEM) operated at an accelerating voltage of 200 kV. Since the electron density of the PDMS block is sufficiently high to provide the necessary mass thickness contrast over the PS block, no staining was needed. TEM images of PS-PDMS fibers are shown in FIGS. 1, 4, 5, 6 and 9. As illustrated in FIG. 7, the total number (N) of block copolymer bilayers is a function of degree of confinement (D/L₀). Furthermore, as shown in FIG. 8, the domain thickness is dependent upon the domain index.

### Example 3

### Image Analysis of Fibers Formed sing Electrospinning (Method 1)

Transmission intensity values were read along a diameter of the cross section and domain boundaries were visually identified as sharp changes in intensity. The diameter for each image was selected manually, along the narrowest dimension of the cross section to mitigate the artifacts of non-perpendicular microtoming.

### Example 4

### Image Analysis of Fibers Formed Using Electrospinning (Method 2)

Complete boundaries between homogeneous regions in the logarithm of transmission intensity distribution were obtained using the region competition algorithm of Zhu and Yuille. Background subtraction and some smoothing were necessary to obtain robust performance. This algorithm finds the edges that optimally separate the image into regions, where pixel intensities are generated by the same probability distribution; here, however, the regions were forced to have concentric topology. The radius of each PS-PDMS interface was determined as that of a circle with the area equivalent to the area enclosed by the interface; domain sizes were calculated based on these radii.

### Example 5

### Formation of Mats From Fibers Formed Using Electrospinning

A mat composed of the PS-PDMS/PMAA core/shell electrospun fibers and the ordered structure formed upon annealing are shown in FIG. 1. The fibers were made using a two-fluid core/shell electrospinning, with 22 wt % PMAA in dimethylformamide (DMF) as the shell fluid and 15 wt % PS-PDMS in a solvent mixture of chloroform and DMF (CHCl₃/DMF=3:1 by volume) as the core fluid. For the data shown here, the operating parameters were as follows: voltage, 33 kV; flow rate of shell fluid, 0.045 ml/min; flow rate of core fluid, 0.005 ml/min; plate to plate distance, 45 cm. Long continuous fibers of PS-PDMS (FIG. 1C) can be produced by removal of the PMAA shell using methanol as the selective solvent. The average diameter of the as-spun core/shell fibers is 800±150 nm, while that of the PS-PDMS fibers is 300±220 nm after removal of the shell. Well-defined concentric lamellar structure is formed within the fiber core, as shown by FIG. 1, D-F. FIG. 1E also shows that the PS block preferentially segregates to the core/shell interface with PMAA due to its lower Flory interaction parameter (χ_{PS/PMAA}=0.14 at 160° C.) compared to that of PDMS with PMAA (χ_{PDMS/PMAA}=0.72 at 160° C.). As expected, this PS monolayer is approximately half as thick as the inner PS domains, which are bilayers.

### Example 6

### Computer Simulation of Fiber Domain Sizes

The simulations were performed using the Molecular Dynamics method with a bead-spring model of the block copolymer that includes bonded interactions for chain connectivity, homogeneous nonbonded interactions to reflect compressibility, and inhomogeneous nonbonded interactions to capture immiscibility between beads of different types. Confinement within a cylindrical geometry was mimicked using a soft boundary constraint. The simulation results indicate that long range order is a consequence of the unique behavior of the central domain in these fibers.

Chain density corresponding to approximately 20 kg/mol polystyrene melt was used to attain a realistic degree of thermal fluctuations, and interaction parameters were chosen in the intermediate segregation regime, where segregation was reliable but interfaces were still wide relative to monomer dimensions. The block copolymer and homopolymer in the system were allowed to interpenetrate to a depth comparable to monomer dimensions to attenuate density artifacts of the walls. The simulation results, illustrated in FIG. 2, confirm that the significant difference between the central domain and outer domains are not due to the polydispersity of the block copolymer. Furthermore, these results are consistent with the schematic for a curved block copolymer interface illustrated in FIG. 3.

### Example 7

### Formation of Fibers Using Electrospinning and Using PS-PDMS Purchased From Polymer Source Inc.

PS-PDMS (total molecular weight of 46.4 kg/mol, PDI of 1.08 and PS volume fraction of about 50%; purchased from Polymer Source Inc.) was electrospun into fibers using similar conditions to those described in Example 1 Specifically, for this PS-PDMS, 22 wt % PMAA in DMF was used as the shell fluid and 18 wt % PS-PDMS in a solvent mixture of chloroform and DMF (CHCl₃/DMF=3:1 by volume) was used as the core fluid. The operating parameters were as follows: voltage, 35 kV; flow rate of shell fluid 0.05 ml/min; flow rate of core fluid 0.004 ml/min; plate to plate distance 50 cm. TEM images of the resulting fibers are shown in FIG. 5. Using this copolymer, the unique behavior for the central domain was confirmed to be independent of the copolymer molecular weight. By comparing FIGS. 1, 4, 5 and 6, this example also demonstrates that the domain sizes can be easily tuned by adjusting the copolymer molecular weight.

### Example 8

### Formation of Fibers Using Electrospinning and Using PS-PMMA Purchased From Polymer Source Inc.

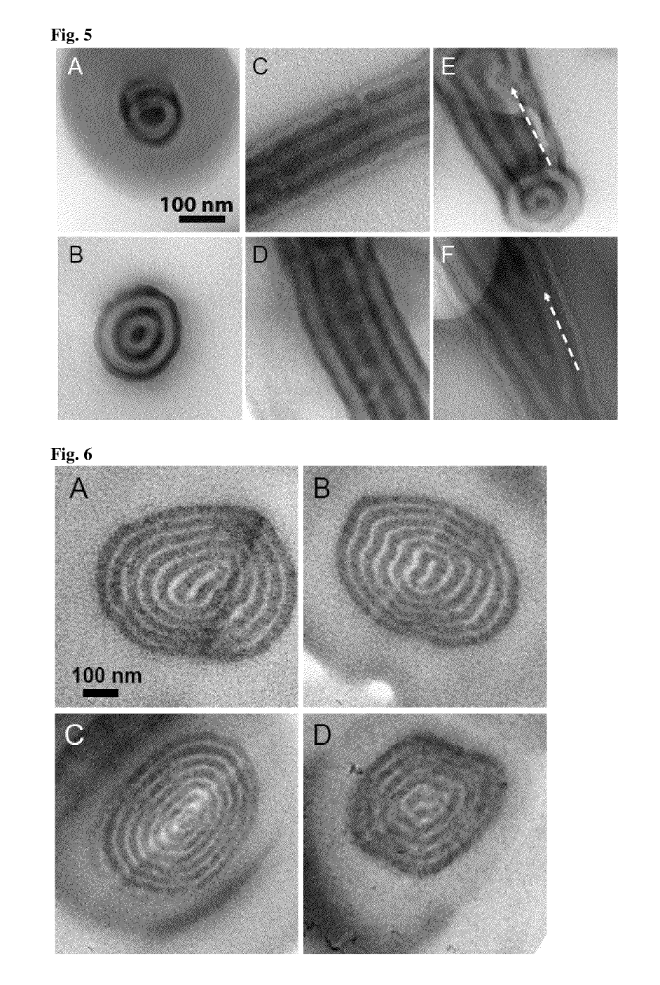

Fibers were made using a two-fluid core/shell electrospinning, with 22 wt % PMAA in DMF as the shell fluid and 24 wt % PS-PMMA in DMF as the core fluid. The operating parameters were as follows: voltage, 33 kV; flow rate of shell fluid 0.04 ml/min; flow rate of core fluid 0.004 ml/min; plate to plate distance 45 cm. TEM images relating to PS-PMMA fibers are illustrated in FIG. 6.

### Example 9

### Microtoming and Imaging of PMMA-based Fibers Formed Using Electrospinning

Electrospun fibers were annealed at 180° C. for 5 days before they were microtomed, stained with ruthenium tetraoxide (RuO₄) and examined using TEM. The annealed fibers were first embedded in epoxy resin (LR White-Medium Grade, Ladd Research) and microtomed into ˜70 nm thick sections at room temperature. The thin sections were transferred onto TEM grids and stained by placing them above a 0.5 wt % ruthenium tetroxide aqueous solution for about 15 minutes. The selectively stained PS domains appear dark, while the unstained PMMA domains are lighter. The outermost PS layers have approximately the same (rather than half) thickness as those interior PS layers, indicating that PMMA actually comprises the outermost domains, but these outermost domains are not resolved in the images due to the low contrast between PMMA and the surrounding PMAA shell. This is in direct contrast to the case of PS-PDMS block copolymers, where PS is always the outermost layer, but consistent with the preferred interaction of PMMA with PMAA (χ_{PS/PMAA}=0.14; χ_{PMMA/PMAA}=0.004 at 180° C.). This example demonstrates that the effect of the interaction between the confining material and block copolymer on its phase structure can be explored; both the chemical and physical properties of the concentric lamellar morphology can be tailored in more detail.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A fiber comprising a copolymer or homopolymer blend wherein said fiber possesses long range order selected from the list comprising concentric lamellae, cylinders, aligned spheres and stacked disks.

2. The fiber of claim 1, wherein said copolymer is a block copolymer comprised of chemically dissimilar monomers wherein said chemically dissimilar monomers are arranged in two or more separate blocks along the length of said block copolymer and wherein said arrangement give rise to phase separation.

3. The fiber of claim 2, wherein said chemically dissimilar monomers are selected from the list comprising styrene, isoprene, butadiene, dimethylsiloxane, methyl methacrylate, acrylonitrile, acrylic acid, ethylene oxide, caprolactone and derivatives thereof.

4. The fiber of claim 1, wherein said copolymer self-assembles into an ordered structure within said fiber and wherein said self-assembly of said copolymer is directed by the chemical dissimilarity of the monomers comprising said copolymer.

5. (canceled)

6. The fiber of claim 1, wherein said fiber may be encased in a shell material.

7. The fiber of claim 6, wherein said shell material is selected from the list comprising poly(methyl methacrylate), poly(methacrylic acid) and poly(methacrylic acid)/poly(methyl methacrylate) copolymer.

8. (canceled)

9. The fiber of claim 2, wherein one of the blocks of said block copolymer is chosen for properties selected from the list comprising reactivity with a chemical species, superhydrophobicity, oleophobicity and ease of removal from the fiber following induction of long range order.

10. (canceled)

11. (canceled)

12. (canceled)

13. (canceled)

14. (canceled)

15. The fiber of claim 6, wherein said shell material is chosen for its ease of removal from the fiber following induction of long range order.

16. The fiber of claim 1, wherein said copolymer is a block copolymer blended with a homopolymer, wherein said homopolymer is miscible with one of the blocks of said block copolymer.

17. (canceled)

18. (canceled)

19. (canceled)

20. (canceled)

21. (canceled)

22. (canceled)

23. The fiber of claim 1, wherein the diameter of said fiber is from 10-1000 nm and wherein said fiber is at least 100 microns in length.

24. (canceled)

25. The fiber of claim 1, wherein the long range order of said fiber persists along the length of said fiber.

26. (canceled)

27. The fibers of claim 1, wherein said fiber exhibits predominantly anisotropic electrical, magnetic or optical properties favoring transmission of electrical, magnetic or optical signals along the length of said fibers.

28. A method of manufacturing a long-range ordered fiber comprising the steps of:
a. Formation of an initial fiber by electrospinning a first solution phase or a first melt phase, wherein said first solution phase or said first melt phase comprises a block copolymer or a copolymer/homopolymer blend and wherein said copolymer comprises polymers of chemically dissimilar monomers; and
b. Annealing said initial fiber to form a fiber comprising long range order selected from the list comprising concentric lamellae, cylinders, aligned spheres and stacked disks.

29. (canceled)

30. (canceled)

31. (canceled)

32. (canceled)

33. The method of claim 28, wherein said chemically dissimilar monomers are selected from the list comprising styrene, isoprene, butadiene, dimethylsiloxane, methyl methacrylate, acrylonitrile, acrylic acid, ethylene oxide, caprolactone and derivatives thereof.

34. The method of claim 28, wherein said initial fiber further comprises a shell.

35. (canceled)

36. The method of claim 34, wherein electrospinning from said first solution phase is carried out in the presence of a second solution phase and wherein said second solution phase comprises said shell material.

37. The method of claim 34, wherein said shell material is selected from the list comprising poly(methyl methacrylate), poly(methacrylic acid) and poly(methacrylic acid)/poly(methyl methacrylate) copolymer).

38. (canceled)

39. (canceled)

40. The method of claim 34, wherein said shell material comprises material having a higher melting temperature or glass transition temperature than said chemically dissimilar monomers.

41. The method of claim 34, wherein the material comprising said shell is chosen for properties selected from the list comprising reactivity with a chemical species, superhydrophobicity, oleophobicity and ease of removal from the fiber following induction of long range order.

42. (canceled)

43. (canceled)

44. (canceled)

45. (canceled)

46. (canceled)

47. The method of claim 34, wherein the composition of said material comprising said shell is varied so that at least one component of said copolymer or at least one component of said homopolymer blend adsorbs preferentially at the interface with said shell.

48. (canceled)

49. The method of claim 28, wherein said first solution phase comprises a mixture of chloroform and N,N-dimethylformamide and wherein said mixture of chloroform and N,N-dimethylformamide is 75% chloroform and 25% N,N-dimethylformamide and wherein said second solution phase comprises said shell material comprises N,N-dimethylformamide.

50. (canceled)

51. (canceled)

52. The method of claim 28, wherein annealing of said initial fiber to form said fiber induces self-assembly of said initial fiber into an ordered structure and wherein said annealing of said initial fiber to form said fiber is chemical or thermal annealing and wherein the temperature of said thermal annealing is higher than the solidification temperature of said copolymer and lower than the solidification temperature of said shell material.

53. (canceled)

54. (canceled)

55. (canceled)

56. (canceled)

57. The method of claim 28, wherein said copolymer self-assembles into an ordered structure within said fiber and wherein said self-assembly of said copolymer is directed by the chemical dissimilarity of the monomers comprising said copolymer.

58. (canceled)

59. (canceled)

60. (canceled)

61. (canceled)

62. (canceled)

63. (canceled)

64. (canceled)

65. (canceled)

66. (canceled)

67. (canceled)

68. The method of claim 28, wherein the diameter of said fiber is from 10-1000 nm and wherein said fiber is at least 100 microns in length.

69. (canceled)

70. The method of claim 28, wherein the long range order of said fiber persists along the length of said fiber.

71. The method of claim 28, wherein said long range order is concentric lamellae.

72. The method of claim 28, wherein said fibers exhibit predominantly anisotropic electrical, magnetic or optical properties favoring transmission of electrical, magnetic or optical signals along the length of said fibers.

73.-135. (canceled)

136. The fiber of claim 1, wherein said fiber is used as a component in a device related to sensors, integrated optical circuits and/or fiber-optic communication devices.

137. The sensors of claim 136, wherein said sensors detects chemical agents, biological agents, trace organic vapors, binding of proteins from solution and the like.
